(19) United States
(12) Patent Application Publication
(10) Pub. No.: US 2005/0198953 A1
(43) Pub. Date: Sep. 15, 2005

(54) Hydrostatic continuously variable transmission

(75) Inventors: Yoshihiro Yoshida, Wako-shi (JP); Yoshihisa Kanno, Wako-shi (JP); Nobuyuki Yakigaya, Wako-shi (JP)

Correspondence Address: MERCHANT & GOULD PC, P.O. BOX 2903, MINNEAPOLIS, MN, 55402-0903, US

(73) Assignee: HONDA MOTOR CO., LTD., Minato-ku (JP)

(21) Appl. No.: 11/081,890

(22) Filed: Mar. 11, 2005

(30) Foreign Application Priority Data
Mar. 12, 2004 (JP) 2004-070330

(51) Int. Cl. F16D 39/00

(52) U.S. Cl. 60/487

(57) ABSTRACT

A hydrostatic continuously variable transmission is formed by connecting a hydraulic pump of a fixed capacity type and a hydraulic motor of a variable capacity type via a hydraulic closed circuit. In this transmission, a pump cylinder and a motor cylinder are connected via a distributing valve to form an output rotor, the output rotor is arranged on a transmission output shaft, one side end face in an axial direction of the output rotor is touched to a regulating part formed on the transmission output shaft, the other side end face is touched to a fitting member attached to the transmission output shaft, and the output rotor is axially positioned and attached on the transmission output shaft.

### TECHNICAL FIELD

The present invention relates to a hydrostatic continuously variable transmission (CVT) configured by connecting a hydraulic pump of a swash plate type and a hydraulic motor of a swash plate type via a hydraulic closed circuit and configured so that at least either capacity of these hydraulic pump and hydraulic motor is variably controlled, the input revolution of the hydraulic pump is shifted, and is output as the output revolution of the hydraulic motor.

### BACKGROUND OF THE INVENTION

For such a hydrostatic continuously variable transmission, configurations of various types are heretofore known and have been realized. For example, a hydrostatic continuously variable transmission disclosed in a patent document 1 is proposed by this applicant. The continuously variable transmission disclosed in the patent document 1 is configured using a hydraulic pump of a swash plate type and a hydraulic motor of a swash plate type, a pump cylinder and a motor cylinder are arranged on an output shaft so that they are revolved integrally with the output shaft, and an output rotor is formed. The end face on the pump side of the output rotor is touched to a flange formed on the output shaft, the movement to the pump side is regulated, and positioning in this direction is performed, in the meantime, the movement in a reverse direction is regulated by a cylindrical sleeve arranged between the end face on the motor side of the output rotor and the side end face of an angular contact bearing that supports the output shaft so that the output shaft can be revolved, and axial positioning is performed. The output shaft is inserted into cylindrical space of the sleeve, the sleeve is attached onto the output shaft, and in this part, the sleeve covers the periphery of the output shaft.

In such a continuously variable transmission, the lubrication of each part is important and particularly, the lubrication of a swash plate face to which the end of a plunger is touched is very important. Therefore, in the continuously variable transmission, lubricating oil supply hole axially extended is formed in the output shaft, a lubricating oil exhaust hole that radially pierces the output shaft from the lubricating oil supply hole to the periphery of the output shaft is formed, and lubricating oil is exhausted to the periphery of the output shaft from the lubricating oil supply hole via the lubricating oil exhaust hole so that a member provided on the output shaft and a member provided in the periphery of the output shaft are lubricated.

[Patent Document 1] JP-A No. 310061/2002

However, the continuously variable transmission disclosed in the patent document 1 has a problem that the sleeve prevents lubricating oil exhausted to the periphery of the output shaft via the lubricating oil exhaust hole as described above from being suitably supplied to a required location because the cylindrical sleeve covering the periphery of the output shaft is arranged to position the output rotor. In this configuration, a lubricating oil exhaust hole can be also provided in the sleeve to supply lubricating oil, however, it is required to position the lubricating oil exhaust hole of the output shaft and the lubricating oil exhaust hole of the sleeve and therefore there is a problem that the positioning requires labor. In this case, if space for an oil reservoir is formed on the inside face of the sleeve, the positioning is not required, however, a problem that the shape of the sleeve is made complex and the cost is increased occurs.

Further, in the continuously variable transmission, a part in which the sleeve is attached on the output shaft passes a through hole formed in the center of a motor swash plate member and the motor swash plate member is arranged with a rocking shaft perpendicular to the central axis of the output shaft in the center so that the swash plate member can be rocked. The above-mentioned configuration in which the part in which the sleeve is attached passes the through hole of the motor swash plate member also has a problem that as the motor swash plate member interferes with the sleeve when the member is rocked, its articulation angle cannot be large so much.

### SUMMARY OF THE INVENTION

The invention is made to solve such problems and the object is to provide a hydrostatic continuously variable transmission having configuration in which a rotor can be positioned and held without providing a sleeve on an output shaft.

To achieve such an object, in the invention, a hydraulic pump of a swash plate type and a hydraulic motor of a swash plate type are connected via a hydraulic closed circuit and a hydrostatic continuously variable transmission is configured, at least either capacity of the hydraulic pump and the hydraulic motor is variably controlled, the input revolution of the hydraulic pump is shifted and is output as the output revolution of the hydraulic motor. The hydraulic pump is provided with a pump swash plate member, a pump cylinder arranged opposite to the pump swash plate member and plural pump plungers which are arranged in plural pump plunger holes axially extended in the pump cylinder in annular arrangement encircling its rotational central axis so that each plunger can be slid and each end of which is touched to the face of the pump swash plate member. The hydraulic motor is provided with a motor cylinder revolved integrally with the pump cylinder, plural motor plungers arranged in plural motor plunger holes axially extended in annular arrangement encircling its rotational central axis in the motor cylinder so that the plural motor plungers can be slid, and a motor swash plate member arranged opposite to the motor cylinder and having a motor swash plate face to which the end of the motor plunger is touched. Further, the pump cylinder and the motor cylinder are connected to be an output rotor and to be arranged on the output shaft, one side end face in the axial direction of the output rotor is touched to a regulating part formed on the output shaft, the other side end face is touched to a fitting member attached to the output shaft, and the output rotor is axially positioned and attached on the output shaft.

It is desirable that the pump cylinder and the motor cylinder are connected with a distributing valve forming a hydraulic closed circuit between them to be an output rotor, the side end face on the side of the pump cylinder of the output rotor is touched to the regulating part, the side end face on the side of the motor cylinder is touched to the fitting member and the output rotor is axially positioned and attached on the output shaft.

Besides, the hydrostatic continuously variable transmission may also be configured so that the pump swash plate member is a swash plate angle fixed type and is arranged on the output shaft so that the pump swash plate member can be revolved, the pump swash plate member is revolved by an engine and axially reciprocates the pump plunger touched to the swash plate face in the plunger hole, the motor swash plate member is a variable oscillation type, the output shaft passes the through hole formed in the center of the motor swash plate member and the motor swash plate member is arranged with an oscillation axis perpendicular to the central axis of the output shaft in the center so that the motor swash plate member can be rocked.

Further, it is desirable that the fitting member is annularly formed, is fitted into an annular groove formed on the periphery of the output shaft, and is attached to the output shaft. At this time, it is desirable that the fitting member is divided in plural, is covered and held from the periphery by an annular holding member attached to the output shaft in a state in which the fitting member divided in plural is fitted into the annular groove.

As described above, in the continuously variable transmission according to the invention, as one side end face in the axial direction of the output rotor is touched to the regulating part formed on the output shaft, the other side end face is touched to the fitting member attached to the output shaft and the output rotor is axially positioned and attached on the output shaft, a sleeve is not required to be used as in the conventional type, the configuration is simple, lubricating oil supplied to the periphery of the output shaft via a lubricating oil supply hole in the output shaft can be supplied to members in the circumference without a problem.

Besides, as no sleeve is provided, the articulation angle of the motor swash plate member can be set to a large value in configuration that the output shaft passes the through hole formed in the center of the motor swash plate member and the motor swash plate member is arranged so that the motor swash plate member can be rocked with the oscillation axis perpendicular to the central axis of the output shaft in the center.

Further, the rotor can be securely positioned and held by the fitting member having simple configuration by annularly forming the fitting member, fitting the fitting member into the annular groove of the output shaft, dividing the annular fitting member in plural, fitting the divided annular fitting member into the annular groove, covering and holding it by the annular holding member.

### BRIEF DESCRIPTION OF THE DRAWINGS

FIG. 1 is a sectional view showing the configuration of a hydrostatic continuously variable transmission according to the invention;

FIG. 2 shows the appearance of a motorcycle provided with the hydrostatic continuously variable transmission;

FIG. 3 is a schematic drawing showing a power transmission path of a power unit provided with the hydrostatic continuously variable transmission;

FIG. 4 is a sectional view showing the configuration of the hydrostatic continuously variable transmission;

FIG. 5 is a sectional view showing the configuration of a part of the hydrostatic continuously variable transmission in an enlarged state;

FIG. 6 is a sectional view showing the configuration of a part of the hydrostatic continuously variable transmission in an enlarged state;

FIG. 7 is a front view and a sectional view showing a cotter member used for positioning a rotor in the hydrostatic continuously variable transmission;

FIG. 8 is a front view and a sectional view showing a retainer ring used for positioning the rotor in the hydrostatic continuously variable transmission;

FIG. 9 is a front view and a sectional view showing a snap ring used for positioning the rotor in the hydrostatic continuously variable transmission;

FIG. 10 is a sectional view showing a motor servo mechanism in the hydrostatic continuously variable transmission;

FIG. 11 is a sectional view showing the structure of a hydraulic pump and a clutch in the hydrostatic continuously variable transmission;

FIG. 12 is a sectional view showing the structure of a transmission output shaft and an output rotor in the hydrostatic continuously variable transmission;

FIG. 13 is a sectional view showing the structure of the transmission output shaft and the output rotor in the hydrostatic continuously variable transmission;

FIG. 14 is a sectional view showing the structure of the transmission output shaft and the output rotor in the hydrostatic continuously variable transmission;

FIG. 15 is a sectional view showing the structure of a lock-up mechanism in the hydrostatic continuously variable transmission;

FIG. 16 is a sectional view showing the structure when the lock-up mechanism is located in a normal position in a state in which it is cut along an arrow Y-Y shown in FIG. 15;

FIG. 17 is a sectional view showing the structure when the lock-up mechanism is located in a lock-up position in the state in which it is cut along the arrow Y-Y shown in FIG. 15; and

FIG. 18 is a hydraulic circuit diagram showing the configuration of fluid passages of the hydrostatic continuously variable transmission.

### DETAILED DESCRIPTION OF THE INVENTION

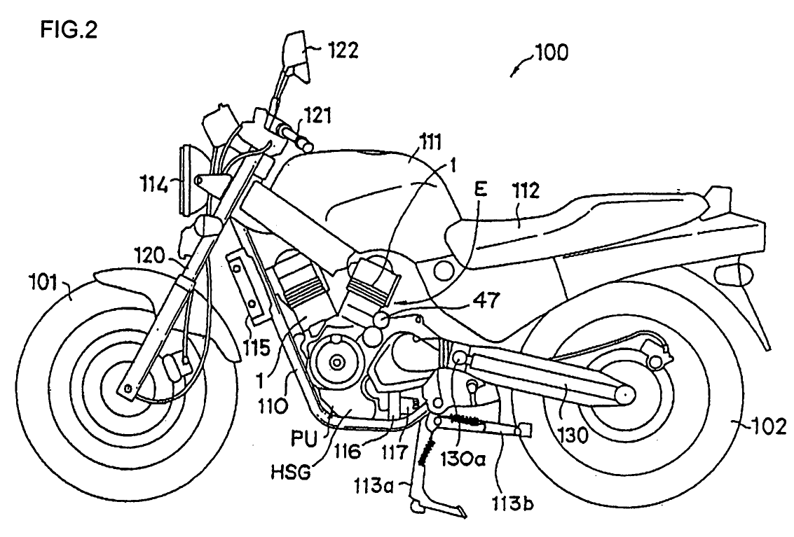

Referring to the drawings, a preferred embodiment of the invention will be described below. First, FIG. 2 shows the whole appearance of a motorcycle provided with a hydrostatic continuously variable transmission according to the invention. In FIG. 2, the motorcycle is shown in a state in which a part of a side cover member of the motorcycle is removed and the internal structure is exposed. This motorcycle 100 is provided with a main frame 110, a front fork 120 attached to the front end of the main frame 110 with a shaft extended diagonally vertically in the center so that the front fork can be turned, a front wheel 101 attached to the lower end of the front fork 120 so that the front wheel can be rotated, a swing arm 130 pivoted in the rear of the main frame 110 with a pivot 130a extended horizontally in the center and attached so that the pivot can be vertically rocked, and a rear wheel 102 attached to the rear end of the swing arm 130 so that the rear wheel can be rotated.

A fuel tank 111, a seat 112 for a rider to sit, a main stand 113a and a substand 113b for holding the body in a state in which the body stands in stopping, a headlight 114 for lighting the front in night running and others, a radiator 115 for cooling engine cooling water, and a power unit PU for generating rotary driving force for driving the rear wheel 102 are attached to the main frame 110. A handlebar (a steering handlebar) 121 for the rider to steer and a rear view mirror 122 for acquiring a rear field of view are attached to the front fork 120. A drive shaft for transmitting rotary driving force generated in the power unit PU to the rear wheel is provided in the swing arm 130 as described later.

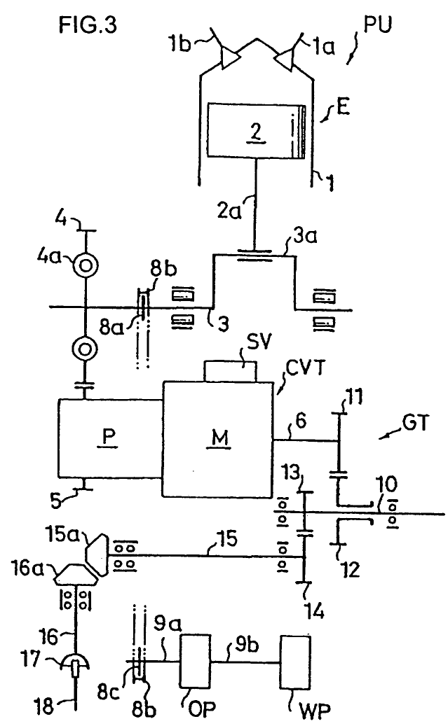

In the motorcycle 100 configured as described above, the hydrostatic CVT according to the invention is used in the power unit PU and the power unit PU will be described below. First, FIG. 3 shows the schematic configuration of the power unit PU. The power unit PU is provided with an engine E that generates rotary driving force, the hydrostatic CVT that enables the continuous shift of its output revolution and a transmission gear train GT that switches a direction of the output revolution of the hydrostatic CVT and transmits the output revolution.

As shown in FIG. 2, the engine E is formed by a V-type engine having a V-type bank and a cylinder 1 is extended longitudinally and diagonally upward in a V type. The engine E is provided with a piston 2 in the cylinder 1 having an intake valve 1a and an exhaust valve 1b in its head. In the engine E, the intake valve 1a and the exhaust valve 1b are opened or closed at predetermined timing, the piston 2 is reciprocated by combusting fuel mixture in the cylinder, the reciprocation of the piston 2 is transmitted to a crank 3a via a connecting rod 2a, and the crankshaft 3 is revolved. An input driving gear 4 provided with a damper 4a is attached to the end of the crankshaft 3 and the rotary driving force of the crankshaft 3 is transmitted to the input driving gear 4.

A driving sprocket 8a is attached to the crankshaft 3 and transmits the rotary driving force to a driven sprocket 8c attached to pump driving shafts 9a, 9b via a chain 8b. An oil pump OP and a water pump WP are arranged on the pump driving shafts 9a, 9b as shown in FIG. 3 and are driven by the engine E. Hydraulic fluid discharged from the oil pump OP is supplied as refilled oil and lubricating oil of the hydrostatic CVT as described later, as shown in FIG. 2, is cooled by an oil cooler 116 arranged in a rear lower part of the power unit PC, and is filtered by an oil filter 117. Cooling water discharged from the water pump WP is used for cooling the engine E and the cooling water turned to high temperature by the engine E is cooled by the radiator 115.

The hydrostatic CVT is provided with a swash plate plunger-type hydraulic pump P and a swash plate plunger-type hydraulic motor M. The input driven gear 5 connected to a pump casing forming the swash plate plunger-type hydraulic pump P is engaged with the input driving gear 4, the rotary driving force of the engine E is transmitted to the input driven gear 5, and the pump casing is revolved. The hydraulic pump P is a fixed capacity type in which the angle of a swash plate is fixed, the hydraulic motor M is a variable capacity type in which the angle of a swash plate is variable and is provided with a motor servo mechanism SV for variably adjusting the angle of a motor swash plate. The details of the hydrostatic CVT are described later, however, output revolution continuously variably shifted by the hydrostatic CVT is output to a transmission output shaft 6.

The transmission gear train GT is connected to the transmission output shaft 6 and for the revolution of the transmission output shaft 6, switching between forward motion and a neutral position and deceleration are performed by the transmission gear train GT. The transmission gear train GT is provided with a counter shaft 10 extended in parallel with the transmission output shaft 6 and a first output driving shaft 15 and includes a first gear 11 connected to the transmission output shaft 6, a second gear 12 arranged so that the second gear can be axially moved toward the counter shaft 10 and can be integrally revolved with the counter shaft 10, a third gear 13 connected to the counter shaft 10 and a fourth gear 14 constantly engaged with the third gear 13 and connected to the first output driving shaft 15. When the second gear 12 is axially moved on the counter shaft 10 according to rider's shift operation and is engaged with the first gear 11, the second gear is turned into a forward-motion state and when the second gear is separated from the first gear 11, the second gear is turned into a neutral state.

In the meantime, an output driving bevel gear 15a is attached to the end of the first output driving shaft 15 and the rotary driving force is transmitted from an output driven bevel gear 16a engaged with the output driving bevel gear 15a to a second output driving shaft 16. The second output driving shaft 16 is connected to a drive shaft 18 via a universal joint 17, as described above, the drive shaft 18 is connected to the rear wheel 102 via the inside of the swing arm 130, the rotary driving force is transmitted to the rear wheel 102, and the rear wheel is driven. The universal joint 18 is located coaxially with the pivot 130a for connecting the swing arm 130 to the main frame 110.

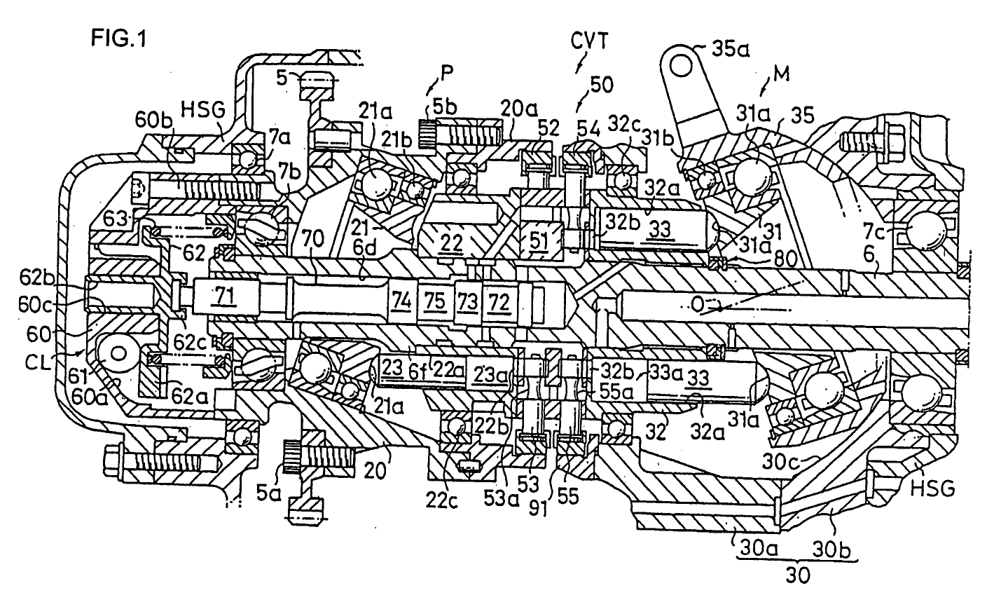

Next, referring to FIG. 1 and FIGS. 4 to 6, the hydrostatic CVT will be described. The hydrostatic CVT is provided with the swash plate plunger-type hydraulic pump P and the swash plate plunger-type hydraulic motor M and the transmission output shaft 6 is extended through the center. The transmission output shaft 6 is supported by a transmission housing HSG via ball bearings 7a, 7b, 7c so that the transmission output shaft can be revolved.

The hydraulic pump P includes a pump casing 20 arranged on the transmission output shaft 6 coaxially with the transmission output shaft so that relative revolution is possible, a pump swash plate member 21 arranged inside the pump casing 20 in a state in which the pump swash plate member is inclined by a predetermined angle from the rotary central shaft of the pump casing 20, a pump cylinder 22 arranged opposite to the pump swash plate member 21 and plural pump plungers 23 arranged in plural pump plunger holes 22a extended axially in annular arrangement encircling the central shaft in the pump cylinder 22 so that the pump plungers can be slid. The pump casing 20 is supported on the transmission output shaft 6 and the pump cylinder 22 by the bearings 7b and 22c so that the pump casing can be revolved and is supported by the transmission housing HSG via the bearing 7a so that the pump casing can be revolved. The pump swash plate member 21 is arranged in the pump casing 20 via bearings 21a, 21b with the axis inclined by the predetermined angle in the center so that the pump swash plate member can be revolved. That is, the pump cylinder 22 is supported by the pump casing 20 via the bearing 22c coaxially so that relative revolution is possible.

The input driven gear 5 is attached to the periphery of the pump casing 20 in a state in which the input driven gear 5 is tightened by a bolt 5a. The outside end of the pump plunger 23 is protruded outside, is touched to the surface 21a of the pump swash plate member 21, and the inside end located in the pump plunger hole 22a forms a pump fluid chamber 23a in the pump plunger hole 22a opposite to the body 51 of a distributing valve 50 described later. A pump opening 22b that acts as a pump discharge port and an intake port is formed at the end of the pump plunger hole 22a. When the input driven gear 5 is revolved as described above, the pump casing 20 is revolved, the pump swash plate member 21 arranged inside it is rocked according to the revolution of the pump casing 20, the pump plunger 23 is reciprocated in the pump plunger hole 22a according to movement by the rock of the wash plate face 21a, and the hydraulic fluid inside the pump fluid chamber 23a is discharged or taken in.

A pump eccentric member 20a is connected to the right end in the drawing of the pump casing 20 via a bolt 5b. The inside face 20b of the pump eccentric member 20a is formed in a cylindrical form eccentric from the rotational axis of the pump casing 20. As the pump eccentric member 20a provided with the inside face 20b eccentric as described above is formed separately from the pump casing 20, the manufacture is easy.

The hydraulic motor M includes a motor casing 30 (formed by plural casings 30a, 30b) connected and fixed to the transmission housing HSG, a motor rocking member 35 supported by being slid on a supporting spherical surface 30c formed on the inside face of the motor casing 30 (the casing 30b) and supported with the center O of the rock extended in a direction of a right angle (a direction perpendicular to a paper surface) with the central axis of the transmission output shaft 6 in the center so that the motor rocking member can be rocked, a motor swash plate member 31 supported in the motor rocking member 35 by bearings 31a, 31b so that the motor swash plate member can be revolved, a motor cylinder 32 opposite to the motor swash plate member 31 and plural motor plungers 33 arranged in plural motor plunger holes 32a axially pierced in annular arrangement encircling the central axis in the motor cylinder 32 so that the motor plungers can be slid. The motor cylinder 32 is supported by the motor casing 30 in its periphery via a bearing 32c so that the motor casing can be revolved.

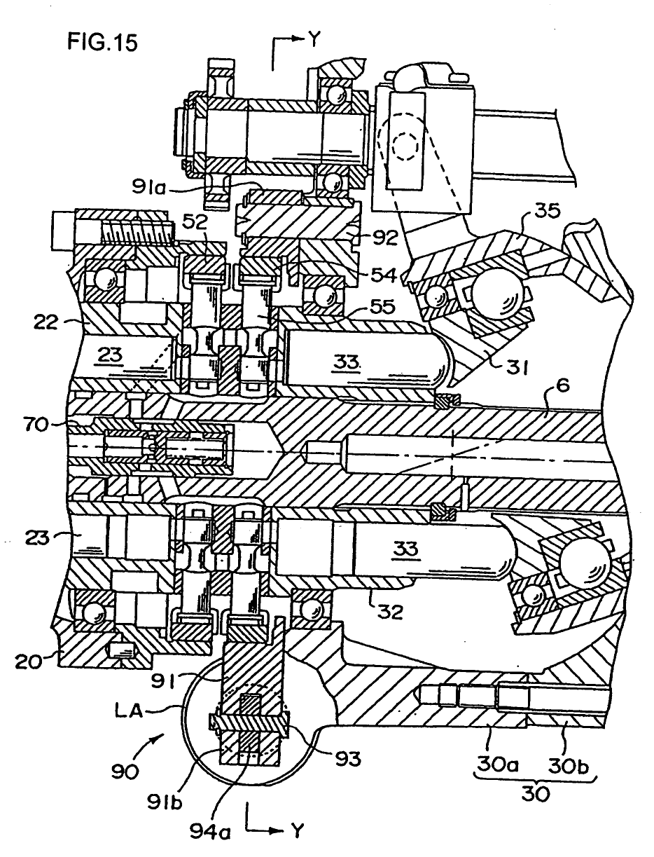

In the hydraulic motor M, a lock-up mechanism 90 (see FIGS. 15 to 17) located at the left end in the drawing of the motor casing 30 is provided and a motor eccentric member 91 forming the lock-up mechanism 90 is touched to the end of the motor casing 30a. The lock-up mechanism 90 will be described later, however, a cylindrical inside face 91a formed in the motor eccentric member 91 is formed so that the cylindrical inside face is moved by a rock between a lock-up position in which the inside face is located coaxially with the motor cylinder 32 and a normal position in which the inside face is located in an eccentric position from the rotational axis of the motor cylinder 32.

The outside end of the motor plunger 33 is protruded outside, is touched to the swash plate face 31a of the motor swash plate member 31, the inside end located in the plunger hole 32a is opposite to the valve body 51, and a motor fluid chamber 33a is formed in the motor plunger hole 32a. At the end of the motor plunger hole 32a, a motor opening 32b that acts as a motor discharge port and an intake port is formed. An arm 35a formed by protruding the end of the motor rocking member 35 on the side of the outside diameter is protruded outside in a radial direction, is coupled to a motor servo mechanism SV, control that the arm 35a is moved laterally in FIG. 1 is made by the motor servo mechanism SV, and control that the motor rocking member 35 is rocked with the center O of the rock in the center is made. As described above, when the motor rocking member 35 is rocked, the motor swash plate member 31 supported by the inside so that the motor swash plate member can be revolved is also rocked together and an angle of the swash plate changes.

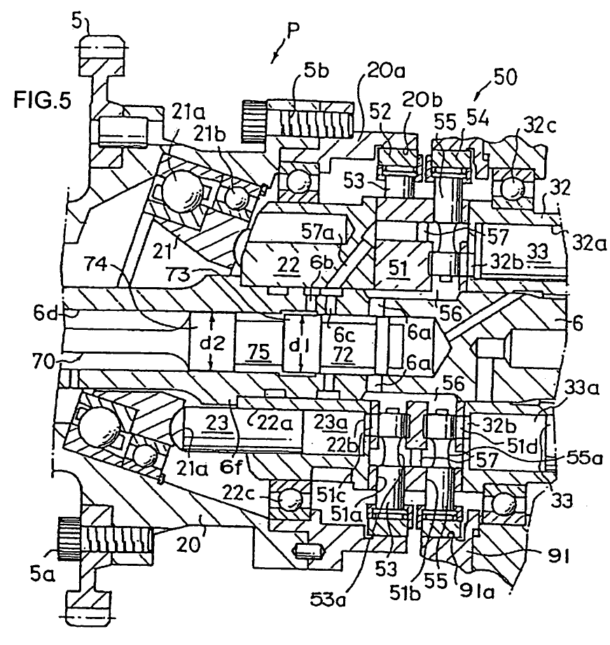

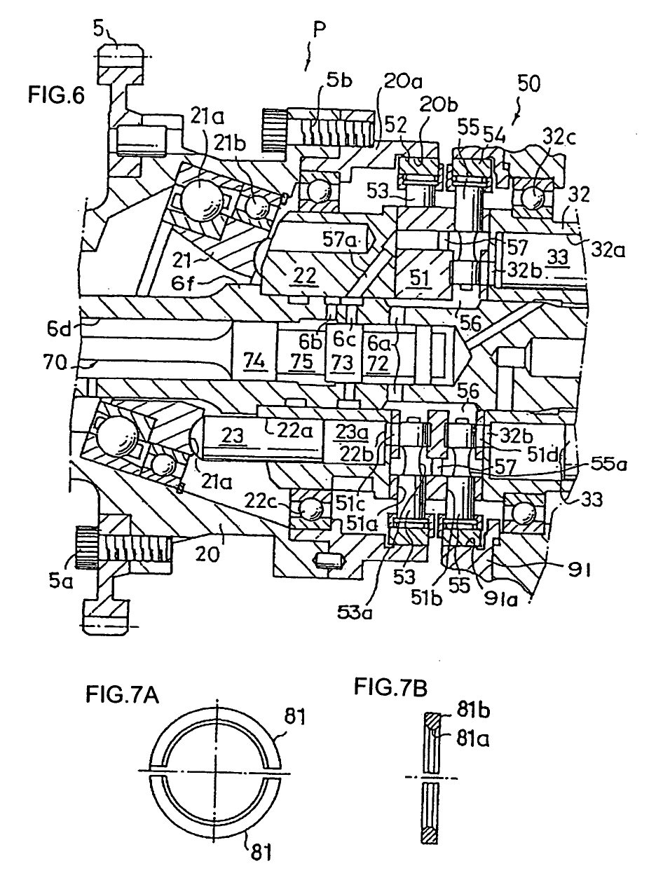

The distributing valve 50 is arranged between the pump cylinder 22 and the motor cylinder 32. FIGS. 5 and 6 show this part with it enlarged, the valve body 51 of the distributing valve 50 is held between the pump cylinder 22 and the motor cylinder 32, is integrated with them by brazing, and the motor cylinder 32 is connected to the transmission output shaft 6 via splines. Therefore, the pump cylinder 22, the distributing valve 50, the motor cylinder 32, and the transmission output shaft 6 are integrally revolved.

As described above, the pump cylinder 22, the distributing valve 50 (the valve body 51 of it) and the motor cylinder 32 respectively integrated are called an output rotor, however, configuration in which the output rotor is positioned in a predetermined position in an axial direction on the transmission output shaft 6 and is attached to the transmission output shaft will be described below. For this positioning, a regulating part 6f protruded like a flange is formed on the periphery of the transmission output shaft 6 and lateral positioning is performed by touching the left end face of the pump cylinder 22 to the regulating part 6f. In the meantime, the positioning in a rightward direction of the output rotor is performed by a fitting member 80 opposite to the right end face of the motor cylinder 32 and attached to the transmission output shaft 6.

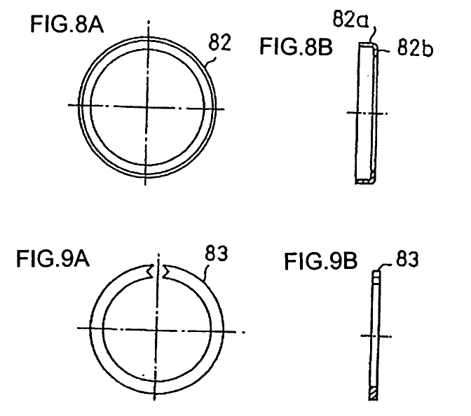

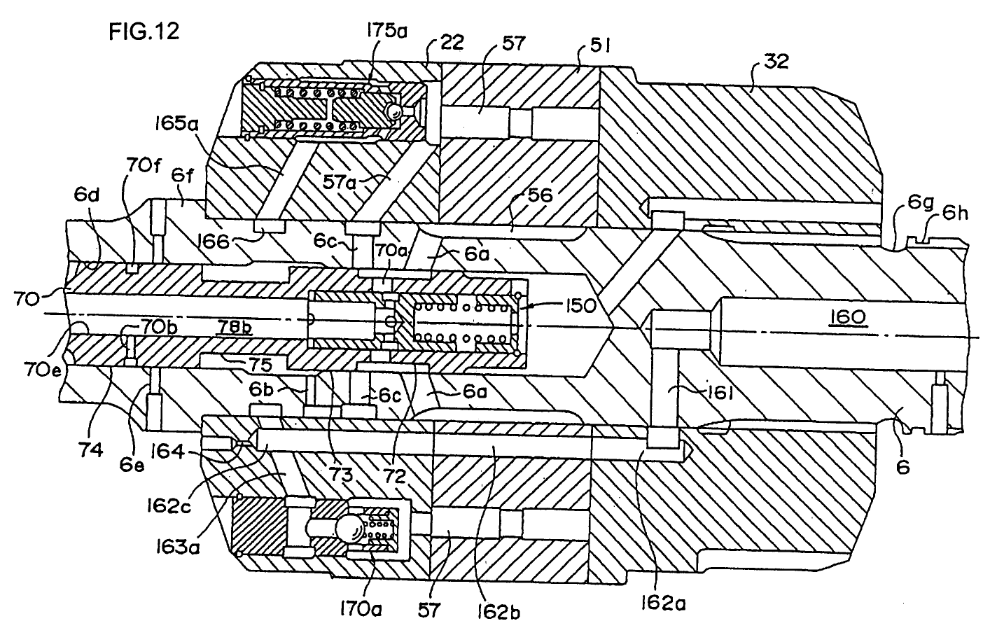

As shown in detail in FIGS. 12 to 14, an annular first fitting groove 6g and a second fitting groove 6h are formed on the transmission output shaft 6 for attachment to the fitting member 80. A pair of cotter members 81 formed by dividing in a semicircle as shown in FIG. 7 are fitted into the first fitting groove 6g in a state in which each inside part 81a is fitted into the first fitting groove 6g. A retainer ring 82 shown in FIG. 8 is attached onto this, the side plate 82b of the retainer ring 82 is touched to the side of the cotter member 81, its peripheral plate 82a covers the peripheral face 81b of the cotter member 81, and the cotter member 81 is held. Further, a snap ring 83 shown in FIG. 9 is attached to the second fitting groove 6h and the retainer ring 82 is held in this state. As a result, the right end face of the motor cylinder 32 is touched to the fitting member 80 and rightward positioning is made. As known from the above-mentioned configuration, the output rotor is positioned on the transmission output shaft 6 with it held between the regulating part 6f and the fitting member 80.

Next, the distributing valve 50 will be described. As shown particularly in FIGS. 5 and 6 detailedly, plural pump-side spool holes 51a and plural motor-side spool holes 51b respectively extended in its radial direction and formed at an equal interval in a direction of its circumference are arranged in two lines in the valve body 51 forming the distributing valve 50. A pump-side spool 53 is arranged in the pump-side spool hole 51a and a motor-side spool 55 is arranged in the motor-side spool hole 51b respectively so that each spool can be slid.

The pump-side spool hole 51a is formed corresponding to the pump plunger hole 22a and plural pump-side communicating passages 51c connecting the corresponding pump opening 22b (the pump fluid chamber 23a) and the corresponding pump-side spool hole 51a are formed in the valve body 51. The motor-side spool hole 51b is formed corresponding to the motor plunger hole 32a and plural motor-side communicating passages 51d connecting the corresponding motor opening 32b (the motor fluid chamber 33a) and the corresponding motor-side spool hole 51b are formed in the valve body 51.

In the distributing valve 50, further, a pump-side cam ring 52 is arranged in a position encircling the peripheral end of the pump-side spool 53 and a motor-side cam ring 54 is arranged in a position encircling the peripheral end of the motor-side spool 55. The pump-side cam ring 52 is attached onto the inside face 20b formed eccentrically from the rotational central axis of the pump casing 20 on the inside face of the pump eccentric member 20a connected to the end of the pump casing 20 by the bolt 5b and is supported by the pump casing 20 so that the pump-side cam ring can be revolved. The motor-side cam ring 54 is attached onto the inside face 91a of the motor eccentric member 91 touched to the end of the motor casing 30. The peripheral end of the pump-side spool 53 is fitted to the inside face of the pump-side cam ring 52 so that relative revolution is possible and the peripheral end of the motor-side spool 55 is fitted to the inside face of the motor-side cam ring 54 so that relative revolution is possible.

An inside passage 56 is formed between the inside face of the valve body 51 and the peripheral face of the transmission output shaft 6, and the inside end of the pump-side spool hole 51a and the inside end of the motor-side spool hole 51b communicate with the inside passage 56. In the valve body 51, an outside passage 57 connecting the pump-side spool hole 51a and the motor-side spool hole 51b is formed.

The operation of the distributing valve 50 having the above-mentioned configuration will be described below. When the driving force of the engine E is transmitted to the input driven gear 5 and the pump casing 20 is revolved, the pump swash plate member 21 is rocked according to the revolution. Therefore, the pump plunger 23 touched to the swash plate face 21a of the pump swash plate member 21 is axially reciprocated in the pump plunger hole 22a according to the rock of the pump swash plate member 21, the hydraulic fluid is discharged from the pump fluid chamber 23a via the pump opening 22b according to movement to the inside of the pump plunger 23, and the hydraulic fluid is taken in the pump fluid chamber 23a via the pump opening 22b according to movement to the outside.

At this time, the pump-side cam ring 52 attached to the inside face 20b of the pump eccentric member 20a connected to the end of the pump casing 20 is revolved together with the pump casing 20, however, as the pump-side cam ring 52 is attached in a state in which it is eccentric from the rotational center of the pump casing 20, the pump-side spool 53 is reciprocated in the radial direction in the pump-side spool hole 51a according to the revolution of the pump-side cam ring 52. As described above, when the pump-side spool 53 is reciprocated and is moved to the side of an inside diameter from a state shown in FIGS. 5 and 6, the pump-side communicating passage 51c and the outside passage 57 communicate with each other via the spool groove 53a and when the pump-side spool 53 is moved to the side of the outside diameter from the state shown in FIGS. 5 and 6, the pump-side passage 51c and the inside passage 56 communicate with each other.

While the swash plate member 21 is rocked according to the revolution of the pump casing 20 and the pump plunger 23 is reciprocated between a position (called a bottom dead center) in which the pump plunger is pushed out most outside and a position (called a top dead center) in which the pump plunger is pushed most inside, the pump-side cam ring 52 reciprocates the pump-side spool 53 in the radial direction. As a result, when the pump plunger 23 is moved from the bottom dead center to the top dead center according to the revolution of the pump casing 20 and the hydraulic fluid in the pump fluid chamber 23a is discharged from the pump opening 22b, the hydraulic fluid is sent to the outside passage 57 via the pump-side communicating passage 51c. In the meantime, when the pump plunger 23 is moved from the top dead center to the bottom dead center according to the revolution of the pump casing 20, the hydraulic fluid in the inside passage 56 is taken in the pump fluid chamber 23a via the pump-side communicating passage 51c and the pump opening 22b. As known from this, when the pump casing 20 is revolved, the hydraulic fluid discharged from the hydraulic pump P is supplied to the outside passage 57 and the hydraulic fluid is taken in the hydraulic pump P from the inside passage 56.

In the meantime, as the motor-side cam ring 54 attached to the inside face 91a of the motor eccentric member 91 touched to the end of the motor casing 30 is eccentric from the center of the revolution of the motor cylinder 32 (the output rotor and the transmission output shaft 6) when the motor eccentric member 91 is located in a normal position, the motor-side spool 55 is reciprocated in the radial direction in the motor-side spool hole 51b according to the revolution when the motor cylinder 32 is revolved. As described above, when the motor-side spool 55 is reciprocated and is moved from a state shown in FIGS. 5 and 6 to the side of the inside diameter, the motor-side communicating passage 51d and the outside passage 57 communicate with each other via a spool groove 55a, and when the motor-side spool 55 is moved from the state shown in FIGS. 5 and 6 to the side of the outside diameter, the motor-side passage 51d and the inside passage 56 communicate with each other. A case that the motor eccentric member 91 is located in a lock-up position will be described later and in this case, the case that it is located in the normal position is described.

As described above, the hydraulic fluid discharged from the hydraulic pump P is sent out to the outside passage 57, is supplied from the motor-side communicating passage 51d to the motor fluid chamber 33a via the motor opening 32b, and the motor plunger 33 is pushed outside in the axial direction. As described above, the outside end of the motor plunger 33 to which pressure toward the outside in the axial direction is applied is configured so that the outside end is touched to a part from the top dead center to the bottom dead center of the motor swash plate member 31 in a state in which the motor rocking member 35 is rocked as shown in FIG. 1 and the motor cylinder 32 is revolved so that the motor plunger 33 is moved from the top dead center to the bottom dead center along the motor swash plate member 31 by the pressure toward the outside in the axial direction.

So as to enable such revolution, while the motor plunger 33 is reciprocated between a position (the bottom dead center) in which the motor plunger is pushed out most outside and a position (the top dead center) in which the motor plunger is pushed most inside according to the revolution of the motor cylinder 32, the motor-side cam ring 54 reciprocates the motor-side spool 55 in the radial direction. As described above, when the motor plunger 33 is moved from the bottom dead center to the top dead center along the motor swash plate member 31 according to the revolution of the motor cylinder while the motor cylinder 32 is revolved, the motor plunger is pushed inside and is moved, and the hydraulic fluid in the motor fluid chamber 33a is sent from the motor opening 32b to the inside passage 56 via the motor-side communicating passage 51d. As a result, the hydraulic fluid sent to the inside passage 56 is taken in the pump fluid chamber 23a via the pump-side communicating passage 51c and the pump opening 22b as described above.

As clear from the above description, when the pump casing 20 is revolved by the revolution of the engine E, the hydraulic fluid is discharged from the hydraulic pump P into the outside passage 57, is sent to the hydraulic motor M and revolves the motor cylinder 32. The hydraulic fluid that finishes revolving the motor cylinder 32 is sent to the inside passage 56 and is taken in the hydraulic pump P from the inside passage 56. As described above, a hydraulic closed circuit connecting the hydraulic pump P and the hydraulic motor M is formed by the distributing valve 50, the hydraulic fluid discharged from the hydraulic pump P according to the revolution of the hydraulic pump P is sent to the hydraulic motor M through the hydraulic closed circuit, the hydraulic motor M is revolved, and further, the hydraulic fluid that finishes revolving the hydraulic motor M and is discharged is returned to the hydraulic pump P through the hydraulic closed circuit.

In this case, when the hydraulic pump P is driven by the engine E, the revolution of the hydraulic motor M is transmitted to the wheels and a vehicle is run, the outside passage 57 functions as a high pressure-side fluid passage and the inside passage 56 functions as a low pressure-side fluid passage. In the meantime, when the driving force of the wheels is transmitted to the hydraulic motor M as in running on a descending slope, the revolution of the hydraulic pump P is transmitted to the engine E and an engine brake is made, the inside passage 56 functions as a high pressure-side fluid passage and the outside passage 57 functions as a low pressure-side fluid passage.

At this time, as the pump cylinder 22 and the motor cylinder 32 are integrally revolved with the transmission output shaft 6 with both cylinders connected to the transmission output shaft 6, the pump cylinder 22 is also revolved together when the motor cylinder 32 is revolved as described above and relative rotational speed between the pump casing 20 and the pump cylinder 22 is reduced. Therefore, relation between the rotational speed Ni of the pump casing 20 and the rotational speed No of the transmission output shaft 6 (that is, relation between the rotational speed of the pump cylinder 22 and the motor cylinder 32) is shown in the following expression (1) in terms of pump capacity Vp and motor capacity Vm.

Mathematical expression
Vp·(Ni−No)=Vm·No (1)

The motor capacity Vm can be continuously varied by control for rocking the motor rocking member 35 by the motor servo mechanism SV. That is, when control that the motor capacity Vm can be continuously varied is made in case the rotational speed Ni of the pump swash plate member 21 is fixed in the expression (1), the revolution of the transmission output shaft 6 is continuously varied, however, as known from this, shift control is performed by rocking the motor rocking member 35 and varying the motor capacity Vm by the motor servo mechanism SV.

When control for reducing the oscillation angle of the motor rocking member 35 is made, the motor capacity Vm is reduced to be control that the revolution of the transmission output shaft 6 is increased so that the revolution approaches the rotational speed Ni of the pump swash plate member 21 in case the pump capacity Vp is fixed and the rotational speed Ni of the pump swash plate member 21 is fixed in the relation in the expression (1), that is, continuous shift control to top speed. When the angle of the motor swash plate is zero, that is, when the motor swash plate is upright, Ni is theoretically equal to No (top transmission gear ratio) to be in a hydraulic locked state, the pump casing 20 is integrally revolved with the pump cylinder 22, the motor cylinder 32 and the transmission output shaft 6, and mechanical power transmission is made.

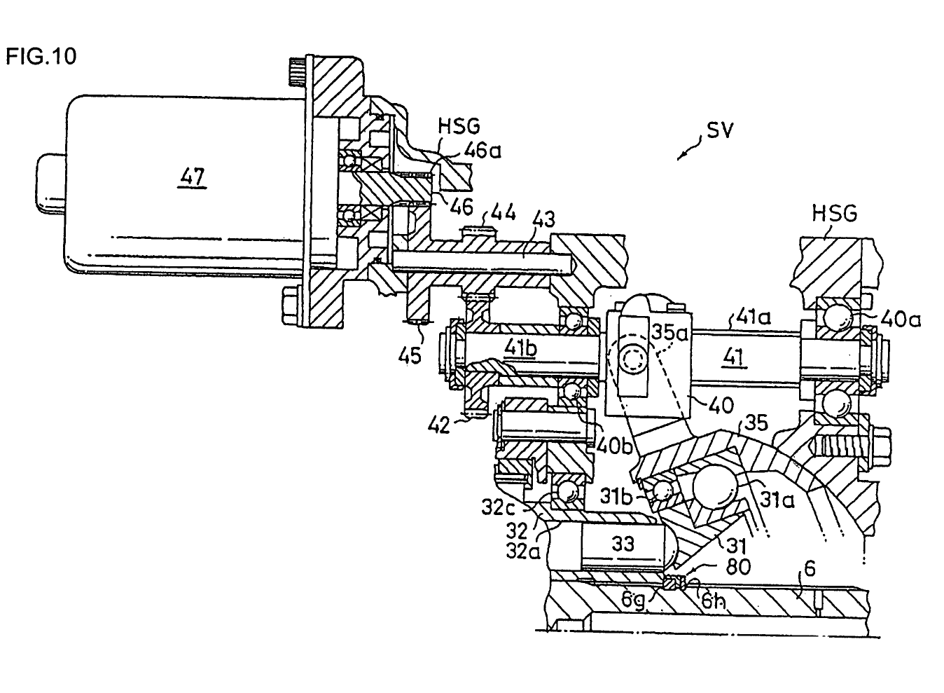

As described above, control for continuously varying motor capacity is made by rocking the motor rocking member 35 and variably controlling the angle of the motor swash plate, however, mainly referring to FIG. 10, the motor servo mechanism SV for rocking the motor rocking member 35 will be described below.

The motor servo mechanism SV is provided with a ball screw shaft 41 located in the vicinity of the arm 35a of the motor rocking member 35, extended in parallel with the transmission output shaft 6 and supported by the transmission housing HSG via bearings 40a, 40b so that the ball screw shaft can be revolved and a ball nut 40 screwed to a male screw 41a formed on the periphery of the ball screw shaft 41. On the inside face of the ball nut 40, a ball female screw is formed by multiple balls spirally arranged by a cage and is screwed on the male screw 41a. The ball nut 40 is coupled to the arm 35a of the motor rocking member 35, when the ball screw shaft 41 is revolved, the ball nut 40 is moved laterally on the ball screw shaft 41, and the motor rocking member 35 is rocked.

To revolve the ball screw shaft 41 as described above, a swash plate control motor (an electric motor) 47 is attached to the outside face of the transmission housing HSG. An idle shaft 43 is provided with the idle shaft extended in parallel with a driving shaft 46 of the swash plate control motor 47 and an idle gear member provided with gears 44 and 45 is attached on the idle shaft 43 so that the idle gear member can be revolved. A gear 46a is formed at the end of the driving shaft 46 of the swash plate control motor 47 and is engaged with the above-mentioned gear 45. In the meantime, a gear 42 is attached to a shaft portion 41b formed by protruding the left side of the ball screw shaft 41 leftward and is engaged with the above-mentioned gear 44.

Therefore, when revolution control over the swash plate control motor 47 is performed and the driving shaft 46 is revolved, the revolution is transmitted to the gear 45, is transmitted from the gear 44 integrally revolved with the gear 45 to the gear 42, and the ball screw shaft 41 is revolved. The ball nut 40 is moved laterally on the shaft 41 according to the revolution of the ball screw shaft 41 and control for rocking the motor rocking member 35 is performed. As described above, as the revolution of the swash plate control motor 47 is transmitted to the ball screw shaft 41 via the gears 46a, 45, 44, 42, transmission ratio can be freely changed by suitably setting the gear ratio of these gears.

The swash plate control motor 47 is exposed outside in the vicinity of the rear side of the base of the rear cylinder 1 in the V-type cylinder engine E as shown in FIG. 2. The cylinder 1 is integrated with the transmission housing HSG and the swash plate control motor 47 is located in space held between the rear cylinder 1 and the transmission housing HSG. As this space can be effectively utilized by arranging the swash plate control motor 47 in the space held between the rear cylinder 1 and the transmission housing HSG as described above and exists in a position separate from the pivot 130a of the swing arm 130 shown in FIG. 2, the shape of the swing arm is never required to be limited to avoid interference with the swing arm 130. The swash plate control motor 47 can be protected from a splash from the lower part of the body in running, rainwater and dust from the front. Further, the swash plate control motor 47 is biased on the left side from the center CL in a lateral direction of the body as shown in FIG. 10 and is effectively cooled by efficiently hitting an air flow flowing from the front in running on the swash plate control motor 47.

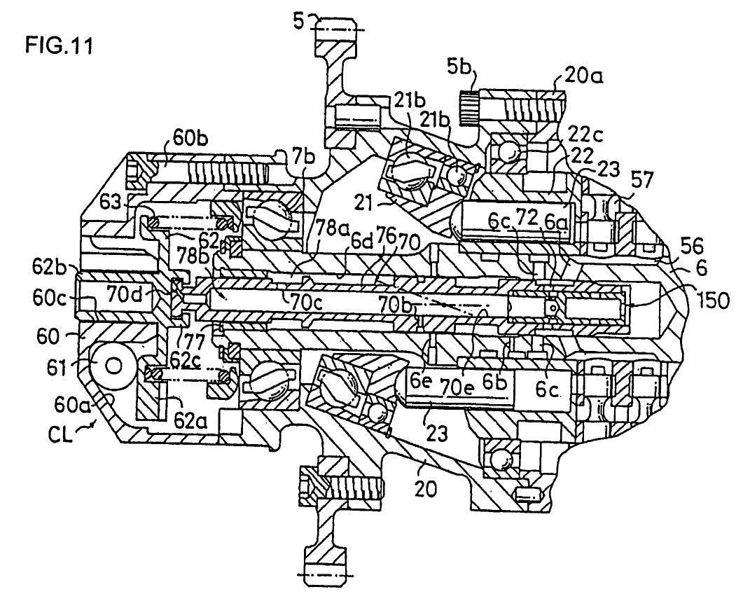

In the hydrostatic CVT configured as described above, when the inside passage 56 and the outside passage 57 are made to communicate, no high-pressure fluid is generated and power transmission between the hydraulic pump P and the hydraulic motor M can be cut off. That is, clutch control is enabled by performing communicating angle control between the inside passage 56 and the outside passage 57. A clutch CL for enabling the clutch control is provided to the hydrostatic CVT and also referring to FIGS. 11 to 14, the clutch CL will be described below.

The clutch CL is provided with a rotor 60 connected to the end of the pump casing 20 by a bolt 60b, weights 61 (balls or rollers) received in plural receiving grooves 60a extended on the inside face of the rotor 60 diagonally in the radial direction, a disc type pressed body 62 having an arm 62a opposite to the receiving groove 60a, a spring 63 for pressing the pressed body 62 so that the arm 62a presses the weight 61 into the receiving groove 60a and a valve spool 70 fitted to a fitting part 62c at one end of the pressed body 62.

A through hole 60c having a rotational central axis in the center is formed in the rotor 60, a cylinder 62b of the pressed body 62 is inserted into the through hole 60c so that the cylinder can be moved, and the pressed body 62 can be axially moved. Therefore, in a state in which the pump casing 20 is stationary and the rotor 60 is also not revolved, the arm 62a presses the weight 61 into the receiving groove 60a by pressure applied to the pressed body 62 by the spring 63. At this time, as the receiving groove 60a is diagonally extended as shown in FIG. 11, the weight 61 is pressed inside in the radial direction and the pressed body 62 is moved leftward as shown in FIGS. 1 and 11.

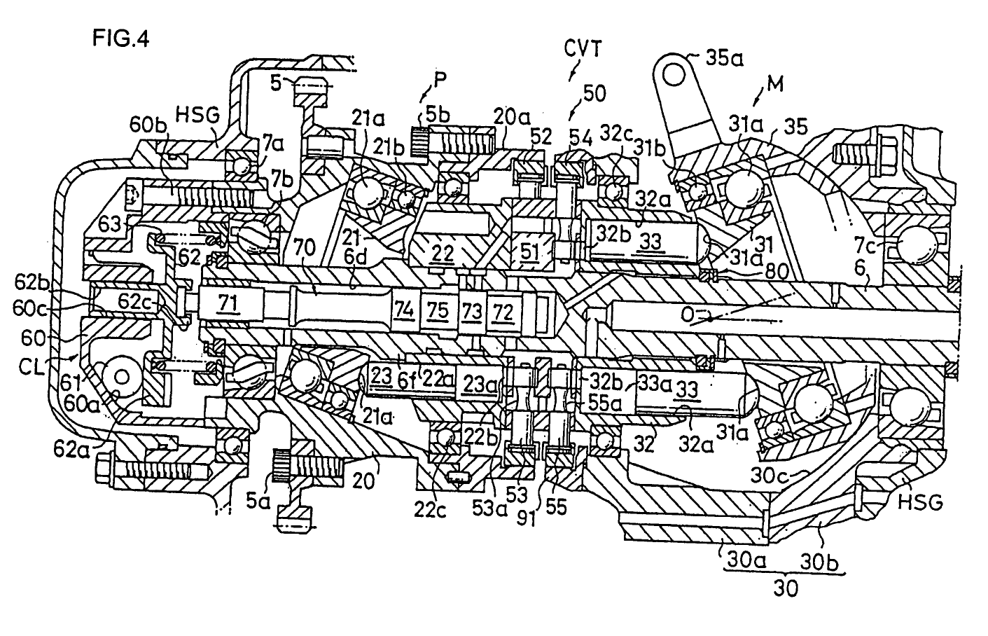

When the pump casing 20 is revolved from this state and the rotor 60 is revolved, the weight 61 is pushed outside in the radial direction in the receiving groove 60a by centrifugal force. When the weight 61 is pushed out in a direction of the outside diameter by centrifugal force as described above, it is moved is moved diagonally rightward along the receiving groove 60a, the arm 62a is pushed rightward, and the pressed body 62 is moved rightward against the pressure of the spring 63. An amount of rightward movement of the pressed body 62 varies according to centrifugal force that acts on the weight 61, that is, the rotational speed of the pump casing 20 and when the rotational speed exceeds predetermined rotational speed, the pressed body is moved to a position shown in FIG. 4 rightward. The valve spool 70 fitted to the fitting part 62c of the pressed body 62 moved laterally in the axial direction as described above is fitted into a spool hole 6d open at the end of the transmission output shaft 6 and axially extended and is moved together with the pressed body 62 laterally in the axial direction.

As known from this, a governor mechanism that generates axial governor force corresponding to the input rotational speed of the hydraulic pump P using centrifugal force that acts on the weight 61 by the revolution of the pump casing 20 is formed by the rotor 60, the weight 61 and the pressed body 62.

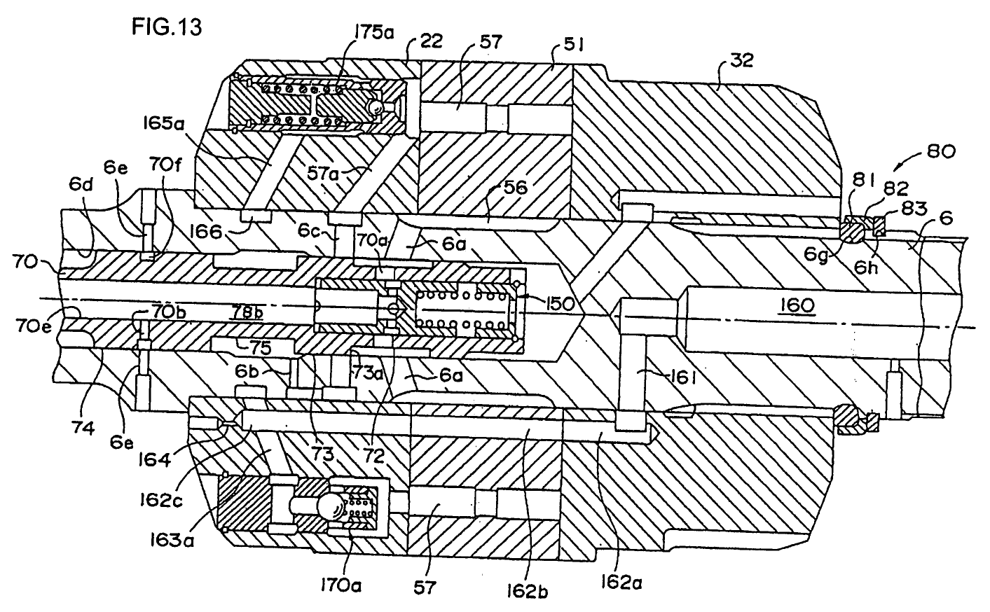

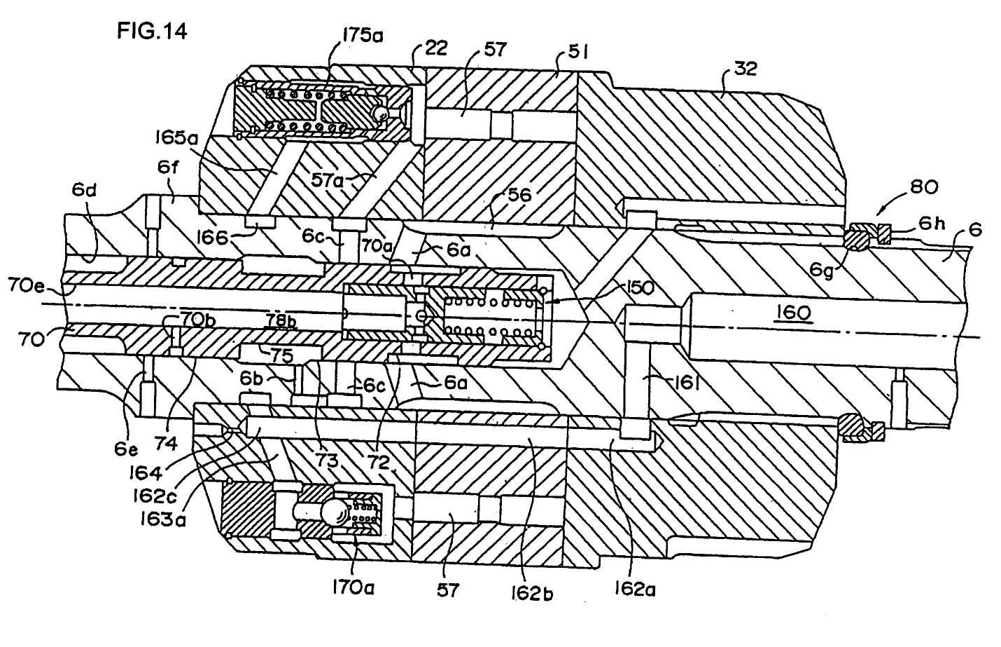

In the meantime, as shown in detail in FIGS. 5, 6, 11 to 14, in the transmission output shaft 6 in which the spool hole 6d is formed, an inside branch fluid passage 6a branched from the inside passage 56 and connected to the spool hole 6d and outside branch fluid passages 6b, 6c connected to the spool hole 6d via a communicating passage 57a branched from the outside passage 57 are formed. FIGS. 5 and 12 correspond to FIG. 1, show a state in which the pressed body 62 is moved leftward and the valve spool 70 is moved leftward, in this state, the inside branch fluid passage 6a and the outside branch fluid passage 6c communicate with each other via a right groove 72 of the valve spool 70, and the inside passage 56 and the outside passage 57 communicate with each other. In the meantime, FIGS. 6 and 14 correspond to FIG. 4, show a state in which the pressed body 62 is moved rightward and the valve spool 70 is moved rightward, in this state, the inside branch fluid passage 6a and the outside branch fluid passage 6c are cut off by a central land part 73 of the valve spool 70, and the inside passage 56 and the outside passage 57 are also cut off. FIG. 13 shows a state in which the valve spool 70 is located in an intermediate position.

As described above, as the valve spool 70 is moved leftward in a state in which the pump casing 20 is in a rotational stationary state, the inside branch fluid passage 6a and the outside branch fluid passage 6c communicate at this time and power transmission between the hydraulic pump P and the hydraulic motor M is cut off to be in a clutch released state. When the pump casing 20 is revolved from this state, the pressed body 62 is gradually moved rightward by centrifugal force that acts on the weight 61 according to its rotational speed and the valve spool 70 is moved rightward together. As a result, the inside branch fluid passage 6a and the outside branch fluid passage 6c are gradually cut off by the central land part 73 of the valve spool 70 and the clutch is gradually engaged.

In the hydrostatic CVT equivalent to this embodiment, when engine speed is slow (in idling) while the pump casing 20 is revolved by the engine E, the valve spool 70 is moved leftward to be in the clutch released state, and as engine speed is accelerated, the clutch is gradually engaged.

The outside diameter d1 of the central land part 73 and the outside diameter d2 of a left land part 74 in the valve spool 70 are set so that d1<d2. Therefore, when the valve spool 70 is moved rightward to be in a clutch engaged state, fluid pressure in the outside passage 57 that acts on a left groove 75 of the valve spool 70 acts in a direction in which the valve spool 70 is moved leftward. The leftward pressure corresponds to the magnitude of the fluid pressure that acts on the left groove 75 and difference in pressed area depending upon difference between the outside diameters d1 and d2. Though the difference in pressed area is fixed, the fluid pressure that acts on the left groove 75 is equivalent to fluid pressure in the outside passage 57, varies according to driving force, and the larger the driving force is, the more the pressure is. This configuration corresponds to the fluid pressure applying means provided in the claims.

As known from this, clutch engagement control by the movement of the valve spool 70 is performed according to balance (Fgov=Fp+Fspg) among governor force (Fgov) generated by centrifugal force that acts on the weight 61 corresponding to the rotational speed of the pump casing 20, the pressure (Fspg) of the spring 63, and pressure (Fp) by the fluid pressure that acts on the left groove 75 of the valve spool 70. Concretely, control that the clutch is engaged as the revolution of the pump casing 20 increases is made and control that force in a direction in which the clutch is released as the fluid pressure of the outside passage 57 increases (as transmission driving force from the hydraulic pump P to the hydraulic motor M increases) is applied is made.

FIG. 13 shows a state of an intermediate stage when clutch engagement/release control is performed as described above, that is, a state of partial clutch engagement. In this state, the right end 73a of the central land part 73 of the valve spool 70 slightly communicates with the outside branch fluid passage 6b to be in a state in which the inside passage 56 and the outside passage 57 partially communicate, that is, the state of partial clutch engagement. In the state of partial clutch engagement, the inside passage 56 and the outside passage 57 are made to communicate or are cut off by the slight axial movement of the valve spool 70, however, as the axial movement of the valve spool 70 is balanced among the governor force (Fgov), the pressure and the pressure by the fluid pressure as described above, the valve spool 70 is operated on the clutch released side when the pressure by the fluid pressure is rapidly increased by the sudden operation of a throttle, the inside passage 56 and the outside passage 57 repeat communication/being cut off, and it becomes difficult to stably transmit power.

Therefore, to stabilize the performance of the clutch by eliminating the movement by too sensitive reaction of the valve spool 70, a buffer mechanism is provided and referring to FIG. 11 in addition to FIGS. 1 and 4, the buffer mechanism will be described below. As shown in the drawings, a variable fluid chamber formation groove 76 is provided on the left side of the left land part 74 in the valve spool 70 and a guide land part 71 having a smaller diameter than that of the left land part 74 is provided on the left side of the variable fluid chamber formation groove 76. The guide land part 71 is fitted into a guide member 77 arranged at the left end of the spool hole 6d and a variable fluid chamber 78a encircled by the spool hole 6d, the guide member 77 and the left land part 74 is formed on the periphery of the variable fluid chamber formation groove 76.

Further, a fluid reservoir formation hole 70e axially extended is formed in the valve spool 70, the right end of the fluid reservoir formation hole 70e is open, a modulator valve 150 is arranged, the left end is closed, and an orifice 70d is formed. As a result, the fluid reservoir formation hole 70e is closed by the modulator valve 150 and a fluid reservoir 78b is formed. In the valve spool 70, a connecting hole 70c for connecting the variable fluid chamber formation groove 76 and the fluid reservoir formation hole 70e is formed, and the variable fluid chamber 78a and the fluid reservoir 78b communicate with each other via the connecting hole 70c.

As described above, the buffer mechanism is formed by the variable fluid chamber 78a and the fluid reservoir 78b communicating via the connecting hole 70c and the operation will be described below. When the valve spool 70 is moved leftward in the axial direction, the volume of the variable fluid chamber 78a decreases because the guide member 77 is fixed in the spool hole 6d, and hydraulic fluid in the fluid chamber is compressed by the left land part 74. At this time, as the volume of the fluid reservoir 78b cannot be varied, the compressive force functions as resistance, the movement of the valve spool 70 is inhibited and moderated. In the meantime, when the valve spool 70 is moved rightward in the axial direction, the volume of the variable fluid chamber 78a increases, however, resistance force against force in a direction in which the volume is increased acts by adjusting (reducing) the diameter of the connecting hole 70c, the movement of the valve spool 70 is inhibited and moderated.

Though the left end of the oil reservoir 70e is closed, the orifice 70d is formed, as the fluid flows in the orifice 70d, the magnitude of the resistance force is regulated by the orifice 70d. The orifice 70d is open to a fitting coupling part between the fitting part 62c of the pressed body 62 and the left end of the valve spool 70, and the fitting coupling part is lubricated by fluid discharged through the orifice 70d.

In the buffer mechanism configured as described above, to fill hydraulic fluid in the variable fluid chamber 78a and the fluid reservoir 78b, the modulator valve 150 is attached and also referring to FIGS. 12 to 14, the modulator valve 150 will be described below. A communicating hole 70a communicating with the modulator valve 150 is formed in the right groove 72 in the valve spool 70, and hydraulic fluid in the right groove 72 flows into the modulator valve 150 via the communicating hole 70a. The modulator valve 150 is a so-called pressure reducing valve, and hydraulic fluid in the right groove 72 is supplied to the fluid reservoir 78b so that fluid pressure in the fluid reservoir 78b is held at predetermined low pressure set by the modulator valve 150. Therefore, hydraulic fluid at the predetermined low pressure set by the modulator valve 150 is constantly filled in the variable fluid chamber 78a and the fluid reservoir 78b.

As fluid in the fluid reservoir 78b is constantly discharged through the orifice 70d, an amount of discharged fluid is refilled via the modulator valve 150. Fluid in the right groove 72 is used for refilling and as the right groove 72 communicates with the fluid passage on the low-pressure side 56 and the fluid passage on the high-pressure side 57 according to a state of the engagement of the clutch, hydraulic fluid in the fluid passage on the low-pressure side 56 and the fluid passage on the high-pressure side 57, that is, hydraulic fluid in hydraulic closed circuit is used for refilled fluid. Therefore, hydraulic fluid in the hydraulic closed circuit is constantly discharged by an amount of refilled fluid, is replaced with new hydraulic fluid (a hydraulic fluid replacement system will be described later), and the hydraulic fluid in the closed circuit can be prevented from having high temperature.

Further, an exhaust hole 70b pierced from the fluid reservoir 78b (the fluid reservoir formation hole 70e) to the outside face of the left land part 74 is formed in the valve spool 70, and an exhaust hole 6e connected from the spool hole 6d to the outside is formed in the transmission output shaft 6. When the valve spool 70 is located in a position of partial clutch engagement as shown in FIG. 13, both exhaust holes 70b, 6e communicate with each other via a peripheral groove 70f of the valve spool 70. As a result, in the state of partial clutch engagement, hydraulic fluid in the fluid reservoir 78b is exhausted outside via both exhaust holes 70b, 6e.

As described above, as in the state of partial clutch engagement, the inside passage 56 and the outside passage 57 partially communicate with each other, and hydraulic fluid flows from the fluid passage on the high-pressure side to the fluid passage on the low-pressure side in the hydraulic closed circuit via the partial communicating part, the-temperature of the hydraulic fluid in the hydraulic closed circuit readily rises. However, when the hydraulic fluid in the fluid reservoir 78b is exhausted outside via both exhaust holes 70b, 6e in the state of partial clutch engagement as described above, its exhausted amount is refilled via the modulator valve 150. As the refilled fluid is refilled from the right groove 72, and the right groove 72 communicates with the fluid passage on the low-pressure side 56 and the fluid passage on the high-pressure side 57 according to a state in which the clutch is engaged, the hydraulic fluid in the hydraulic closed circuit is used for hydraulic fluid in the fluid passage on the low-pressure side 56 and the fluid passage on the high-pressure side 57, that is, for refilled fluid. Therefore, the hydraulic fluid in the hydraulic closed circuit is constantly exhausted by an amount of refilled fluid, is replaced with new hydraulic fluid (the hydraulic fluid replacement system will be described later), and particularly, in the state of partial clutch engagement, the hydraulic fluid in the closed circuit can be effectively prevented from having high temperature.

In the hydrostatic CVT configured as described above, the lock-up mechanism 90 that closes the hydraulic closed circuit to be in a lock-up state in a state in which the transmission gear ratio is 1.0, that is, in a state in which the input revolution of the hydraulic pump P and the output revolution of the hydraulic motor M are equal is provided. Referring to FIGS. 15 to 17, the lock-up mechanism 90 will be described below. The lock-up mechanism 90 is provided with the motor eccentric member 91 touched to the end of the motor casing 30a as described above. The motor eccentric member 91 is formed in the form of a ring as a whole and the motor-side cam ring 54 is arranged on its inside face 91a. A fitting part 91a is formed at the upper end of the motor eccentric member 91, is connected to the motor casing 30a by a fitting pin 92, and the motor eccentric member 91 can be rocked in relation to the motor casing 30a with the fitting pin 92 in the center.

To rock the motor eccentric member 91, a lock-up actuator LA is attached to the motor casing 30b under the motor eccentric member 91. The lock-up actuator LA is formed by a cylinder 96 fixed to the motor casing 30b, a piston 94 arranged in a cylinder hole of the cylinder 96 so that the piston can be slid, a lid member 95 attached to the cylinder 96 to close the cylinder hole, and a spring 97 for pushing the piston 94 toward the lid member 95. The cylinder hole is divided in two by the piston 94, a lock-up hydraulic fluid chamber 96a and a lock-up release chamber 96b are formed, and the spring 97 is arranged in the lock-up release chamber 96b. The end of the piston 94 is protruded outside from the cylinder 96 and the protruded part 94a is coupled to a coupling part 91b formed under the motor eccentric member 91 via a coupling pin 93.

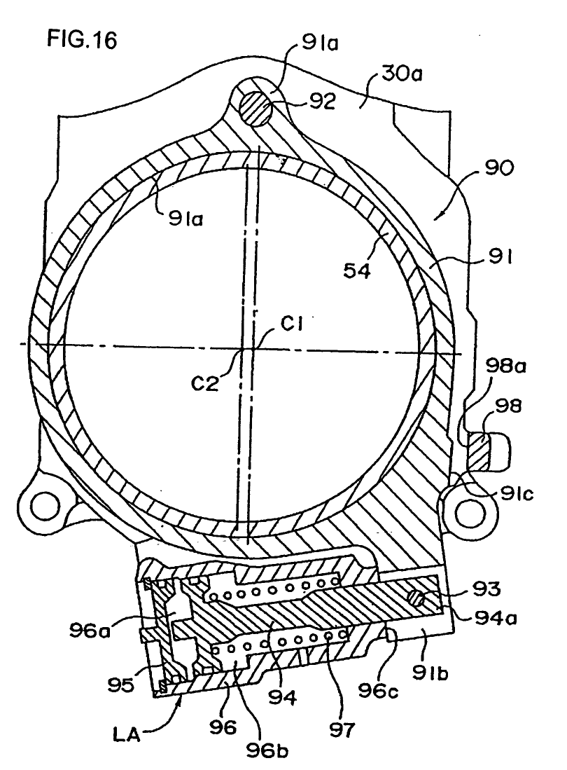

In the lock-up mechanism 90 configured as described above, when fluid pressure in the lock-up hydraulic fluid chamber 96a is released, the piston 94 is moved to the side of the lid member 95 by the pressure of the spring 97 arranged in the lock-up release chamber 96b. At this time, as shown in FIG. 16, the coupling part 91b is touched to the outside end face 96c of the cylinder 96, in this state, the center C2 of the inside face 91a of the motor eccentric member 91 is eccentric from the center C1 of the transmission output shaft 6 and the output rotor (the motor cylinder 32), and the motor eccentric member 91 is located in a normal position.

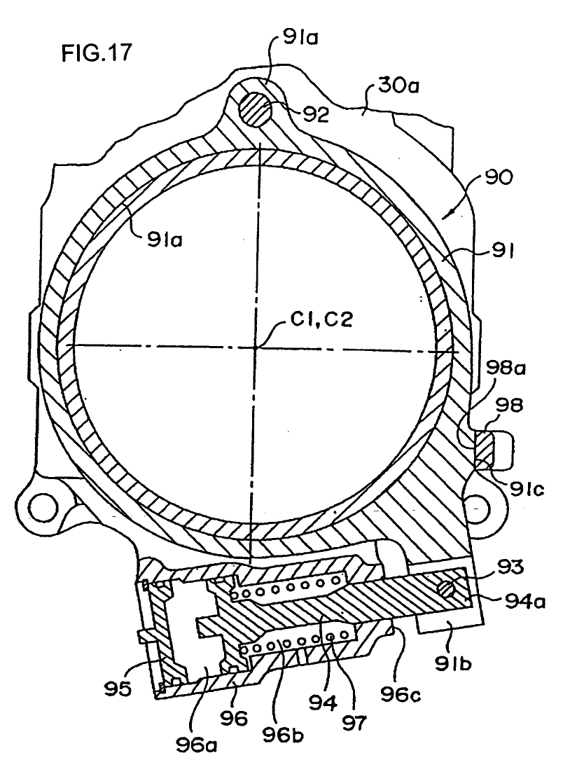

In the meantime, when lock-up hydraulic fluid pressure is supplied to the lock-up hydraulic fluid chamber 96a, the piston 94 is moved rightward in FIG. 16 against the pressure of the spring 97 by the fluid pressure and the protruded part 94a is further protruded. Hereby, the motor eccentric member 91 is rocked counterclockwise in FIG. 16 with the fitting pin 95 in the center, and as shown in FIG. 17, a contact face 91c formed on the side of the motor eccentric member 91 is touched to a contact face 98a of a positioning protrusion 98 integrated with the motor casing 30a. In this state, the center C2 of the inside face 91a of the motor eccentric member 91 is overlapped with the center C1 of the transmission output shaft 6 and the output rotor (the motor cylinder 32), and the motor eccentric member 91 is located in a lock-up position.

As known from the configuration of the hydraulic motor M and the configuration of the distributing valve 50, when the motor eccentric member 91 is located in the lock-up position, the center of the motor-side cam ring 54 arranged on its inside face 91a is coincident with the rotational center of the motor cylinder 32, even if the motor cylinder 32 is revolved, the motor-side spool 55 is not reciprocated, and the supply of high-pressure fluid to the motor plunger 33 is cut off. At this time, the motor eccentric member communicates with the fluid passage on the low-pressure side 56. As a result, compression loss and the leakage of hydraulic fluid in the motor plunger 33 can be reduced, the loss of mechanical power such as in a bearing can be reduced by no application of high pressure to the motor plunger 33, further, the resistance in sliding of the pump-side spool 53 can be reduced, and power transmission efficiency is enhanced.

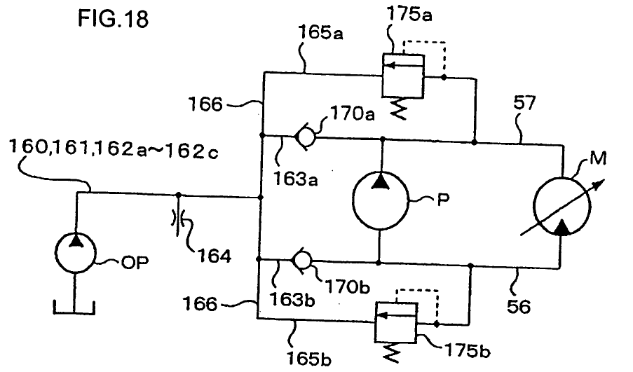

Next, referring to FIGS. 12 to 14 and FIG. 18, a system for refilling hydraulic fluid in the hydraulic closed circuit will be described. As shown in FIG. 18, hydraulic fluid is refilled by the oil pump OP (see FIG. 3) and fluid discharged from the oil pump OP driven by the engine E is supplied to a fluid passage 160 axially extended in the transmission output shaft 6 via a fluid passage in the transmission housing HSG. The end of the fluid passage 160 is connected to a fluid passage 161 extended in the radial direction in the transmission output shaft 6 and open to the periphery. The fluid passage 161 is further connected to fluid passages 162a, 162b, 162c axially extended in the output rotors (the motor cylinder 32, the valve body 51, and the pump cylinder 22), an orifice 164 communicating with the outside is formed at the end of the fluid passage 162c, and the inside of the transmission is lubricated by hydraulic fluid that flows outside via the orifice 164.

In the pump cylinder 22, a first check valve 170a for supplying refilled fluid to the outside passage 57 and a first relief valve 175a for relieving hydraulic fluid when fluid pressure in the outside passage 57 exceeds predetermined high pressure are provided as shown in FIGS. 12 to 14. Further, though they are not shown in FIGS. 12 to 14, a second check valve 170b for supplying refilled fluid to the inside passage 56 and a second relief valve 175b for relieving hydraulic fluid when fluid pressure in the outside passage 57 exceeds the predetermined high pressure respectively having the similar configuration to these are also provided.

As shown in the drawings, a fluid passage 163a for connecting the fluid passage 163c and the first check valve 170a is formed in the pump casing 22 and hydraulic fluid supplied from the oil pump OP is supplied to the outside passage 57 via the first check valve 170a if necessary (according to a leak from the hydraulic closed circuit) as refilled fluid. For the fluid passages 162a, 162b, 162c, plural are formed, a fluid passage 163b for connecting the fluid passage 162c and the second check valve 170b is formed in the pump cylinder 22, and hydraulic fluid supplied from the oil pump OP is supplied to the inside passage 56 via the second check valve 170b if necessary (according to a leak from the hydraulic closed circuit) as refilled fluid.

In the meantime, hydraulic fluid relieved via the first relief valve 175a when fluid pressure in the outside passage 57 exceeds predetermined high pressure set by pressing means is exhausted into a return fluid passage 165a formed in the pump cylinder 22. The return fluid passage 165a is formed on the peripheral face of the transmission output shaft 6 in the form of a ring and communicates with a ring-type fluid passage 166 fitted and encircled to/by the pump cylinder 22. The fluid passage 166 communicates with the fluid passage 162c via the fluid passage 163a, and as known from this, hydraulic fluid relieved from the first relief valve 175a is exhausted into a supply fluid passage of refilled fluid supplied from the oil pump OP. Hydraulic fluid relieved from the second relief valve 175b, though it is not shown, is also exhausted from the return fluid passage 165b into the fluid passage 162c, that is, the refilled fluid supply passage via the ring-type fluid passage 166 and the fluid passage 163b.

As described above, the hydraulic fluid relieved from the first and second relieve valves 175a, 175b is exhausted into the refilled fluid supply passage 162c via the return fluid passages 165a, 165b, and as relief fluid is not returned to the hydraulic closed circuit, the rise of the temperature of fluid in the hydraulic closed circuit can be inhibited. Beside, as fluid pressure in the refilled fluid supply passage 162c is kept stable, hydraulic fluid in the fluid passage on the high-pressure side can be efficiently relieved.

As the refilled fluid supply passage is extended from the transmission output shaft 6 to the output rotor, the first and second relieve valves 175a, 175b and the return fluid passages 165a, 165b are arranged in the pump cylinder 22 (the output rotor) and the return fluid passages 165a, 165b are connected to the refilled fluid supply passage 162c in the pump cylinder 22, the return fluid passages 165a, 165b can be shortened and thereby high-pressure relief structure can be housed compactly in the pump cylinder 22. Besides, the return fluid passages 165a, 165b are connected to the refilled fluid supply passage 162c (and 163a, 163b) via the ring-type fluid passage 166 circumferentially extended in a part in which the transmission output shaft is fitted to the pump cylinder 22 on the peripheral face of the transmission output shaft 6 and therefore fluid passage coupling structure in this part is simple.

The embodiment in which the continuously variable transmission according to the invention is adopted in the motorcycle has been described, however, the invention is not limited to application to a motorcycle and can be adopted in various power transmission mechanisms such as a vehicle including a four-wheel vehicle and an automobile and a general machine.

The above specification, examples and data provide a complete description of the manufacture and use of the composition of the invention. Since many embodiments of the invention can be made without departing from the spirit and scope of the invention, the invention resides in the claims hereinafter appended.

1. A hydrostatic continuously variable transmission comprising:
a hydraulic pump of a swash plate type connected to a hydraulic motor of a swash plate type via a hydraulic closed circuit and configured so that a least either a capacity of the hydraulic pump or a capacity of the hydraulic motor is variably controlled to control the relative rotational speeds of the hydraulic pump input and the hydraulic motor output, wherein:
the hydraulic pump includes:
a pump swash plate member;
a pump cylinder arranged opposite to the pump swash plate member; and
a plurality of pump plungers arranged in a plurality of pump plunger holes axially extended in the pump cylinder in an annular arrangement encircling a central rotational axis of the pump cylinder such that the pump plungers can slide when the pump plungers contact the face of the pump swash plate member;
the hydraulic motor includes:
a motor cylinder that rotates at least in part in response to the rotation of the pump cylinder;
a plurality of motor plungers arranged in a plurality of motor plunger holes axially extended in the motor cylinder in an annular arrangement encircling a central rotational axis of the motor cylinder such that the motor plungers can slide within the holes; and
a motor swash plate member arranged opposite to the motor cylinder and having a motor swash plate face to which ends of the motor plungers contact;
wherein the pump cylinder and the motor cylinder are connected to form a part of an output rotor and are arranged on an output shaft; and
wherein one end of the output rotor abuts a first stop formed on the output shaft and the opposite end of the output rotor abuts a second stop attached to the output shaft, and the output rotor is axially positioned on and attached to the output shaft.

2. The transmission according to claim 1, wherein:
the pump cylinder and the motor cylinder are connected via a distributing valve that together with the output rotor forms a part of the hydraulic closed circuit; and
the pump cylinder is adjacent the end of the output rotor that abuts the first stop and the motor cylinder is adjacent the end that abuts the second stop.

3. The transmission according to claim 1, wherein:
the pump swash plate member includes a swash plate having a fixed angle and an aperture therein for receiving an output shaft such that the pump swash plate member can be revolved around the output shaft;
the pump swash plate member is constructed to be revolved by an engine to axially reciprocate the pump plungers in the plunger holes that are in contact with the swash plate;
the motor swash plate member is a variable oscillation type having a center aperture therein for the output shaft to pass through; and
the motor swash plate member is arranged so that it can be rocked with an oscillation axis perpendicular to the central axis of the output shaft.

4. The transmission according to claim 1, wherein the second stop member comprises an annularly formed fitting member that is fitted into an annular groove formed on the periphery of the output shaft.

5. The transmission according to claim 4, wherein:
the fitting member includes a cotter, a retainer, and a snap ring; and
the cotter seats in the annular groove, the retainer secures the cotter in place radially and the snap ring secures the cotter in place axially.

6. A hydrostatic continuously variable transmission comprising:
a hydraulic pump including a fixed angle swash plate and a cylinder;
a variable capacity hydraulic motor in fluid communication with the hydraulic pump, the motor including a variable angle swash plate and a cylinder; and
wherein the pump cylinder and the motor cylinder are disposed axially along an output shaft.

7. The transmission according to claim 6, wherein the output shaft include a stepped portion that inhibits the pump and motor cylinders from moving past a first point on the output shaft.

8. The transmission according to claim 6, wherein the output shaft includes an annular groove for receiving a cotter for inhibiting the pump and motor cylinders from moving past a second point on the output shaft.

9. The transmission according to claim 6, wherein the pump cylinder and the motor cylinder forms part of a rotor assembly, wherein the end of the rotor assembly adjacent the pump cylinder abuts a stepped portion on the output shaft, and wherein the end of the rotor assembly adjacent the motor cylinder abuts a cotter disposed in an annular groove in the output shaft.

10. The transmission according to claim 9, further comprising an annular retainer for securing the cotter in the radial direction.

11. The transmission according to claim 10, further comprising a snap ring disposed in an annular groove on the output shaft for securing the retainer in the axial direction.

12. A hydrostatic continuously variable transmission comprising:
a hydraulic pump of a swash plate type connected to a hydraulic motor of a swash plate type via a hydraulic closed circuit and configured so that a least either a capacity of the hydraulic pump or a capacity of the hydraulic motor is variably controlled to control the relative rotational speeds of the hydraulic pump input and the hydraulic motor output, wherein:
the hydraulic pump includes:
a pump swash plate member;
a pump cylinder arranged opposite to the pump swash plate member; and
a plurality of pump plungers arranged in a plurality of pump plunger holes, each hole axially extended in the pump cylinder in an annular arrangement encircling a central rotational axis of the pump cylinder such that the pump plungers can slide when the pump plungers contact the face of the pump swash plate member;
the hydraulic motor includes:
a motor cylinder that rotates at least in part in response to the rotation of the pump cylinder;
a plurality of motor plungers arranged in a plurality of motor plunger holes axially extended in the motor cylinder in an annular arrangement encircling a central rotational axis of the motor cylinder such that the motor plungers can slide within the holes, and a motor swash plate member arranged opposite to the motor cylinder and having a motor swash plate face to which an end of the motor plungers contact;
a securing means for securing the pump cylinder and the motor cylinder to an output shaft.
